(19) United States
(12) Patent Application Publication
(10) Pub. No.: US 2017/0300051 A1
(43) Pub. Date: Oct. 19, 2017

(54) Amphibious vertical take off and landing unmanned device with AI data processing apparatus

(71) Applicants: Dylan T X Zhou, Tiburon, CA (US); Tiger T G Zhou, Tiburon, CA (US); Andrew H B Zhou, San Gabriel, CA (US); Zhou Tian Xing, Tiburon, CA (US)

(72) Inventors: Dylan T X Zhou, Tiburon, CA (US); Tiger T G Zhou, Tiburon, CA (US); Andrew H B Zhou, San Gabriel, CA (US); Zhou Tian Xing, Tiburon, CA (US)

(21) Appl. No.: 15/345,308

(22) Filed: Nov. 7, 2016

Related U.S. Application Data
(63) Continuation-in-part of application No. 29/572,722, filed on Jul. 29, 2016.
Application No. 29/572,722 is a continuation-in-part of application No. 29/567,712, filed on Jun. 10, 2016.
Application No. 29/567,712 is a continuation-in-part of application No. 14/940,379, filed on Nov. 13, 2015, now Pat. No. 9,493,235.
Application No. 14/940,379 is a continuation-in-part of application No. 14/957,644, filed on Dec. 3, 2015, now Pat. No. 9,489,671.
Application No. 14/957,644 is a continuation-in-part of application No. 14/815,988, filed on Aug. 1, 2015, now Pat. No. 9,342,829.
Application No. 14/815,988 is a continuation-in-part of application No. 13/760,214, filed on Feb. 6, 2013, now Pat. No. 9,016,565.

(51) Int. Cl. G05D 1/00; F03D 9/25; G08G 5/04; G08G 5/00; B64D 47/08; H04N 5/232; F03D 9/32; B64C 25/32; B64C 29/00; B64C 39/02; B64D 27/24; H04N 5/247; G01S 19/13

(52) U.S. Cl. CPC G05D 1/0038; H04N 5/247; F03D 9/25; G08G 5/04; G08G 5/003; G05D 1/0016; G01S 19/13; H04N 5/23238; F03D 9/32; B64C 25/32; B64C 29/0033; B64C 39/024; B64D 27/24; B64D 47/08; B64C 2201/066; B64C 2201/108; B64C 2201/127; B64C 2201/027; B64C 2201/042; B64D 2211/00

(57) ABSTRACT

An amphibious VTOL unmanned aerial device, comprising, the cameras is adapted for providing a real-time first-person video and a real-time first-person view and normal footage video recording and 360-degree panoramic video recording used for virtual reality views and interactive video, the communication system to communicate with plurality of other devices Plurality of rotors, the rotors are adapted for creating the thrust, the solar panel is adapted for converting the solar energy to electrical use,the rear propeller is adapted for horizontal flight and also used as wind turbine to charge the batteries. The Al control device to control the various control surfaces and communication system, plurality of sensors, to detect the location of the drones, the stabilization system to stabilize the camera and the drone during the flight.

### CROSS-REFERENCE TO RELATED APPLICATIONS

This application is a continuation-in-part of U.S. application Ser. No. 29/572,722, entitled “Amphibious vtol, hover, backward, leftward, rightward, turbojet, turbofan, rocket engine, ramjet, pulse jet, afterburner, and scramjet single/dual all in one jet engine (fuel/electricity) with onboard self computer based autonomous module gimbaled swivel propulsion (GSP) system device, same as ducted fan(fuel/electricity)”, filed Jul. 29,2016.

This application is a continuation-in-part of U.S. application Ser. No. 29/567,712, entitled“ Amphibious vtol, hover, backward, leftward, rightward, turbojet. turbofan, rocket engine, ramjet, pulse jet, afterburner, and scramjet all in one jet engine (fuel/electricity) with onboard self computer based autonomous gimbaled swivel propulsion system device” filed Jun. 10, 2016.

This application is a continuation-in-part of U.S. application Ser. No. 14/940,379, entitled “AMPHIBIOUS VERTICAL TAKEOFF AND LANDING UNMANNED SYSTEM AND FLYING CAR WITH MULTIPLE AERIAL AND AQUATIC FLIGHT MODES FOR CAPTURING PANORAMIC VIRTUAL REALITY VIEWS, INTERACTIVE VIDEO AND TRANSPORTATION WITH MOBILE AND WEARABLE APPLICATION”. filed Nov. 13, 2015.

This application is a continuation-in-part of U.S. application Ser. No. 14/957,644 (publication no. 2016/0086,161), entitled “SYSTEMS AND METHODS FOR MOBILE APPLICATION, WEARABLE APPLICATION, TRANSACTIONAL MESSAGING, CALLING, DIGITAL MULTIMEDIA CAPTURE AND PAYMENT TRANSACTIONS”, filed Dec. 3, 2015; which is continuation-in-part of U.S. patent application Ser. No. 14/815,988 (publication no. 2015/0371,215), entitled “SYSTEMS AND METHODS FOR MOBILE APPLICATION, WEARABLE APPLICATION, TRANSACTIONAL MESSAGING, CALLING, DIGITAL MULTIMEDIA CAPTURE AND PAYMENT TRANSACTIONS” filed Aug. 1, 2015; which is continuation-in-part of Ser. No. 13/760,214 filed Feb. 6, 2013, which in turn is a continuation-in-part of Ser. No. 10/677,098 which claims priority to Provisional Application Ser. No. 60/415,546, filed on Oct. 1, 2002, the content of which is incorporated herein by reference in its entirety.

### FIELD OF THE INVENTION

The present invention relates a drone. More specifically, the present invention relates to an amphibious VTOL super drone adapted self-powered solar cells and wind turbine with field view mapping and advanced collision system.

### BACKGROUND OF THE INVENTION

The conventional drones are adapted for flying and capturing the environment with simple 2d pictures and does not communicate with the other unmanned vehicles there by collision occurs, and conventional drones do not have self-powered solar cells and wind turbine which also used as horizontal flight propeller to have super speed. Conventional drones do not have folding functions to act as mobile phone cases also. The present invention overcomes such problems.

### OBJECT OF INVENTION

Object of the present invention is to provide an amphibious VTOL super unmanned aerial vehicle with field view mapping and advanced collision system. And these invented amphibious VTOL super drones have self-powered solar cells and wind turbine which also used as horizontal flight propeller to have super speed. And these new invented drones have folding functions to act as mobile phone cases to perform selfie and selfie video.

Another object of the present invention is to provide an unmanned aerial vehicle with field view mapping and advanced collision system which can capture area mapping.

Yet another of the present invention is to provide an unmanned aerial vehicle with field view mapping and advanced collision system which can communicate with other unmanned vehicles.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to the present invention a VTOL unmanned aerial vehicle with field view mapping and advanced collision system is provided. The VTOL unmanned aerial vehicle comprises a plurality of cameras, a plurality of rotors, a power supplying unit, a landing gear, a control device and a communication system. The plurality of cameras are adapted for providing a real-time first-person video and a real-time first-person view and normal footage video recording and 360-degree panoramic video recording used for virtual reality views and interactive videos.

The plurality of rotors are configured laterally on a periphery of the unmanned aerial vehicle adapted for creating a thrusting force thereby moving the unmanned aerial vehicle towards the thrusting force. The power supplying unit is for supplying power to the plurality of rotors for moving the unmanned aerial vehicle. The landing gear is adapted for safe landing of the unmanned aerial vehicle. The control device is adapted to set a flight path and area to map by the unmanned aerial vehicle. The communication system is adapted for sharing the flight path and position of the unmanned aerial vehicle thereby controlling the unmanned aerial vehicle in a predetermined path.

### BRIEF DESCRIPTION OF DRAWING

FIG. 1 is a close up of the isometric view of the first example of the present invention.

FIG. 2 is a close up of the top view of the first example of the present invention.

FIG. 3 is a close up of the bottom view of the first example of the present invention.

FIG. 4 is a close up of the top view of the first example of the present invention with different embodiments.

FIG. 5 is a close up of the bottom view of the first example of the present invention, with different embodiments.

FIG. 6 is a close up of the front view of the first example of the present invention.

FIG. 7 is a close up of the rear view of the second example of the present invention.

FIG. 8 is a close up of the isometric view of the present invention, with different embodiments.

FIG. 9 is a close up of the isometric view of the present invention, with different embodiments.

FIG. 10 is a close up of the isometric view of the present invention, with different embodiments.

FIG. 11 is a close up of the isometric view of the present invention, with different embodiments.

FIG. 12 is a close up of the isometric view of the present invention, with different embodiments, with solar panels.

FIG. 13 is a close up of the isometric view of the present invention, with different embodiments.

FIG. 14 is a close up of the isometric view of the present invention, with different embodiments, under water.

FIG. 15 is a close up of the isometric view of the present invention, with different embodiments.

FIG. 16 is a close up of the isometric view of the second example of the present invention.

FIG. 17 is a close up of the top view of the second example of the present invention.

FIG. 18 is a close up of the bottom view of the second example of the present invention

FIG. 19 is a close up of the front view of the second example of the present invention.

FIG. 20 is a close up of the rear view of the second example of the present invention.

FIG. 21 is a close up of the left view of the second example of the present invention.

FIG. 22 is a close up of the right view of the second example of the present invention

FIG. 23 is a close up of the isometric view of the second example of the present invention, with different working positions.

FIG. 24 is a close up of the isometric view of the second example of the present invention, with different working positions.

FIG. 25 is a close up of the isometric view of the second example of the present invention, with different working positions.

FIG. 26 is a close up of the isometric view of the second example of the present invention, with different working positions.

FIG. 27 is a close up of the isometric view of the second example of the present invention, with different working positions.

FIG. 28 is a close up of the isometric view of the second example of the present invention, with different working positions.

FIG. 29 is a close up of the isometric view of the second example of the present invention, with different working positions.

FIG. 30 is a close up of the isometric view of the second example of the present invention, with different working positions and in underwater.

FIG. 31 is a close up of the isometric view of the third example of the present invention.

FIG. 32 is a close up of the top view of the third example of the present invention.

FIG. 33 is a close up of the bottom view of the third example of the present invention.

FIG. 34 is a close up of the front view of the third example of the present invention.

FIG. 35 is a close up of the rear view of the third example of the present invention.

FIG. 36 is a close up of the left view of the third example of the present invention.

FIG. 37 is a close up of the right view of the third example of the present invention.

FIG. 38 is a close up of the isometric view of the third example of the present invention, with different working positions.

FIG. 39 is a close up of the isometric of the third example of the present invention, with different working positions.

FIG. 40 is a close up of the isometric view of the third example of the present invention, with different working positions, with solar panels embedded on the surface.

FIG. 41 is a close up of the isometric view of the third example of the present invention, with different working positions.

### DETAILED DESCRIPTION OF THE INVENTION

All illustrations of the drawings are for the purpose of describing selected versions of the present invention and are not intended to limit the scope of the present invention.

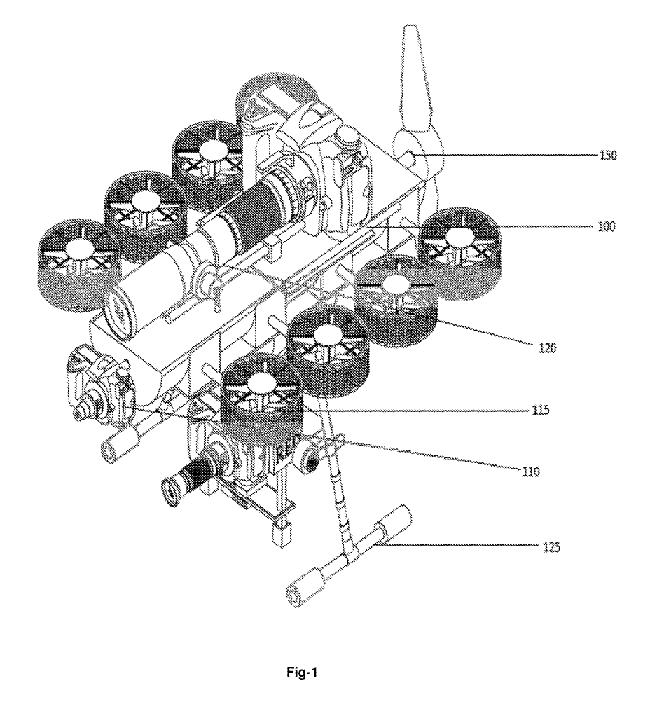

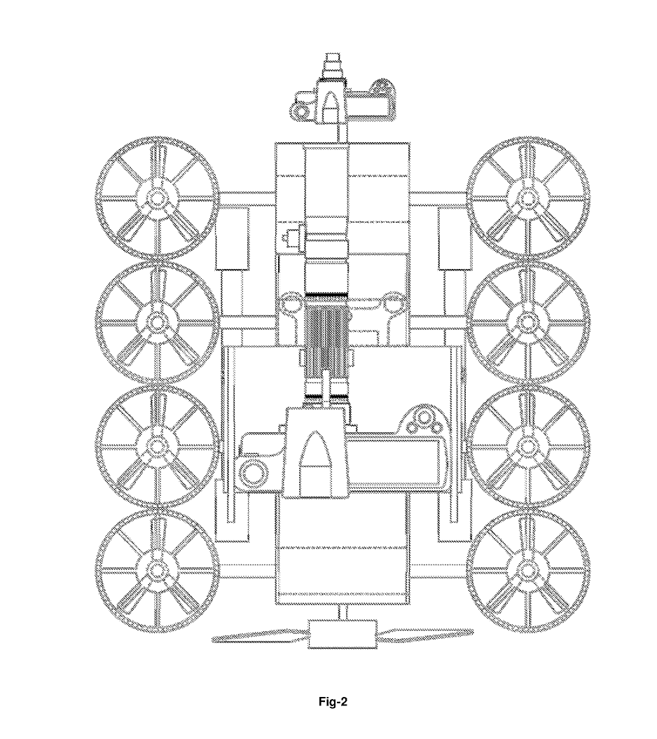

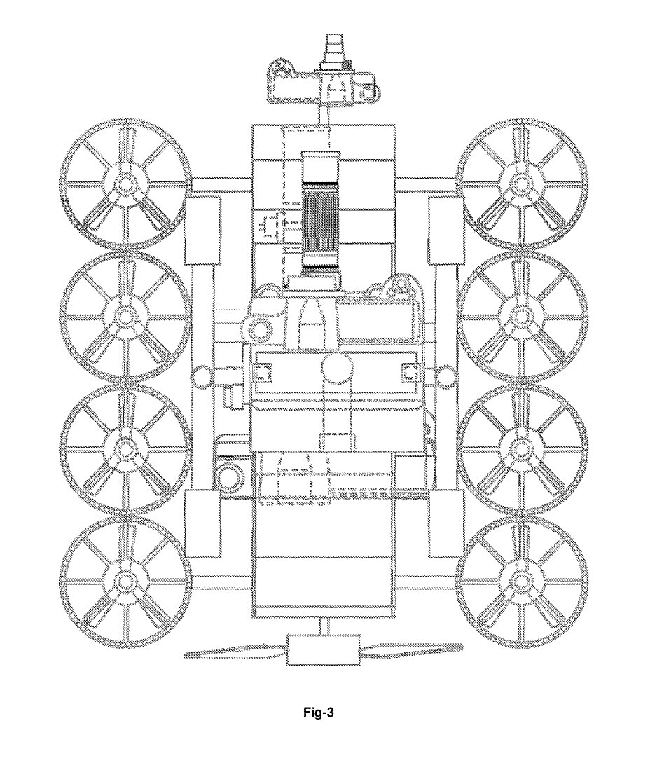

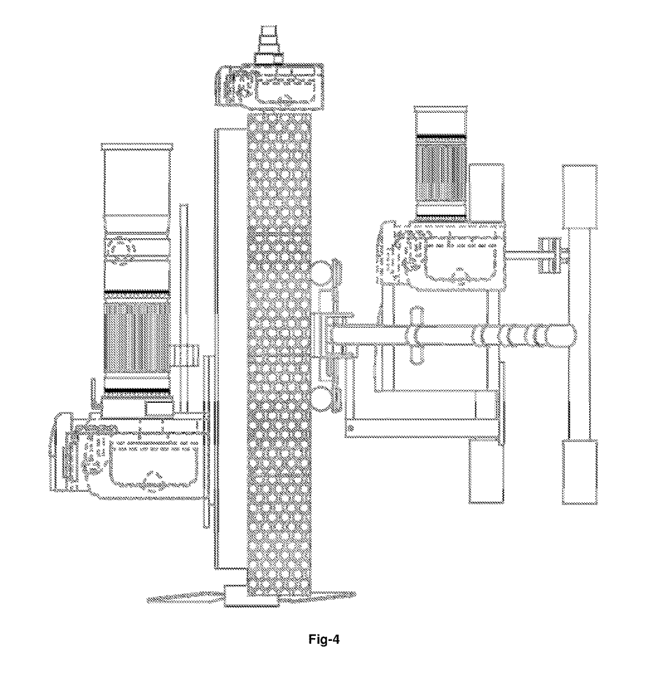

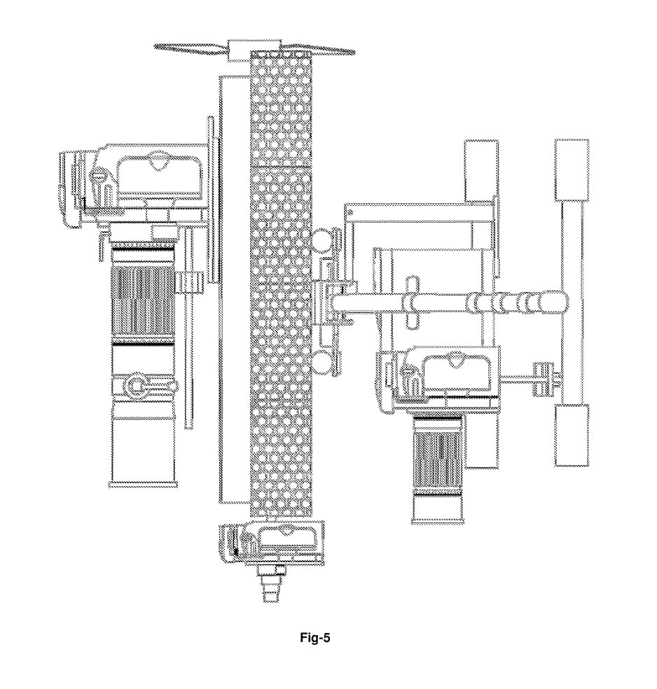

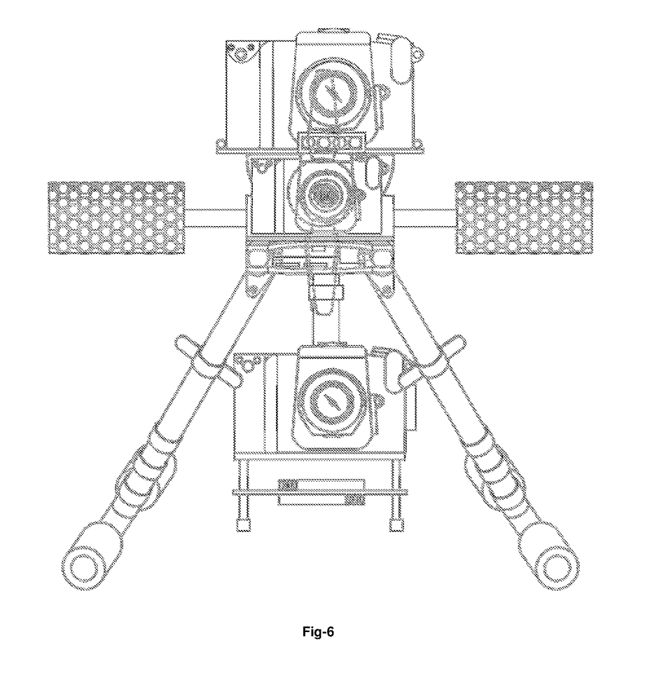

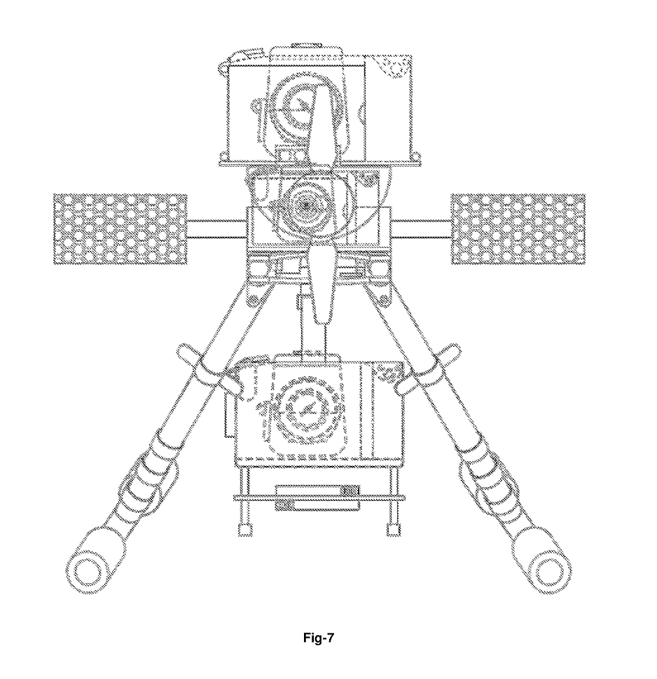

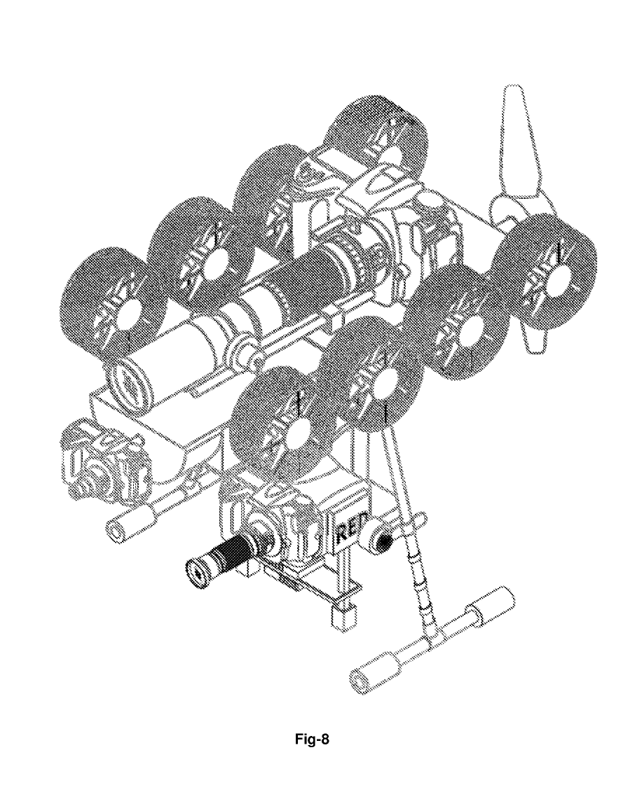

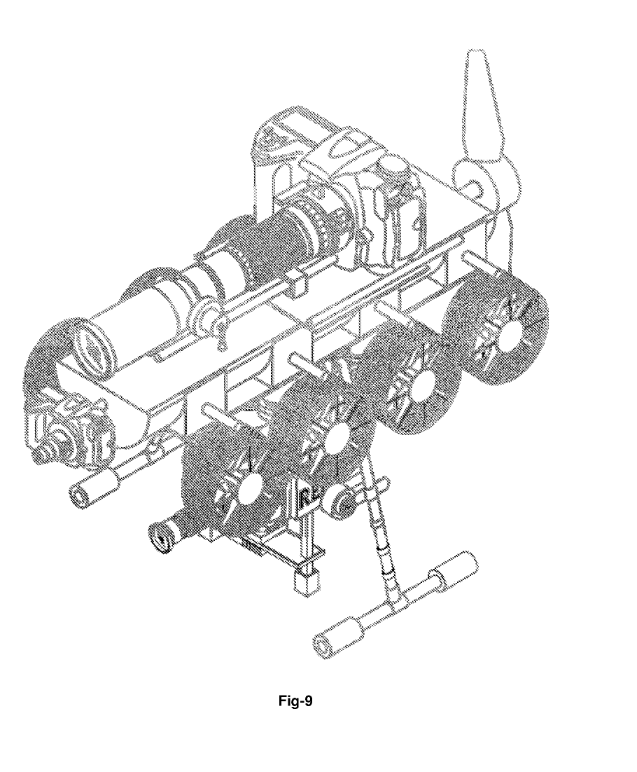

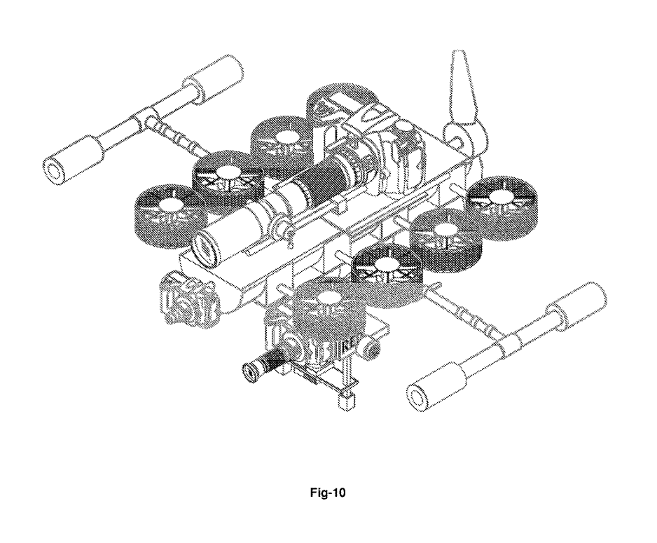

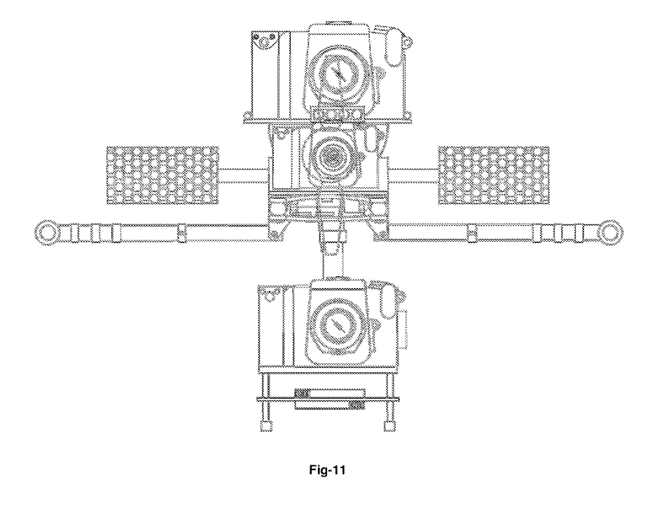

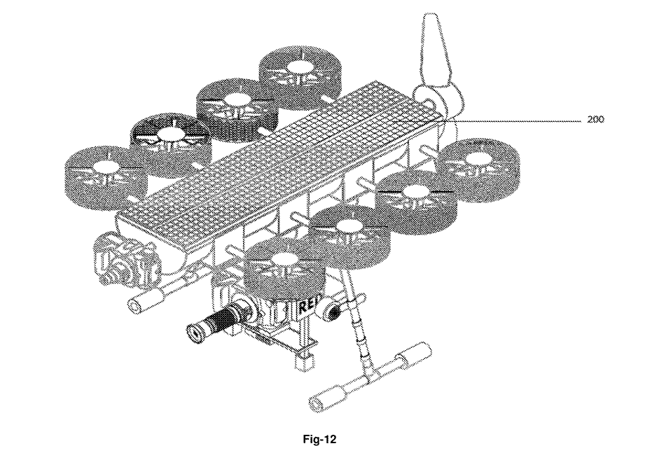

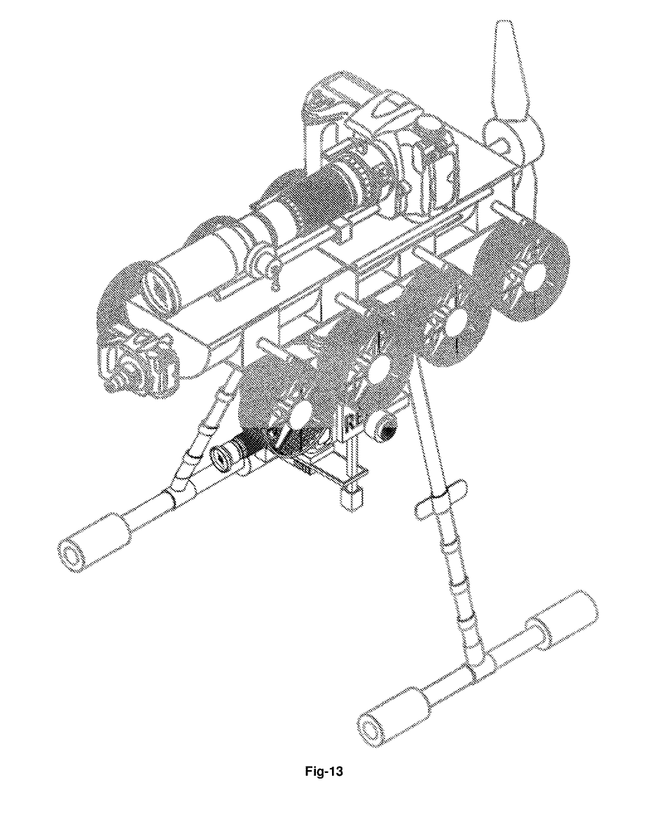

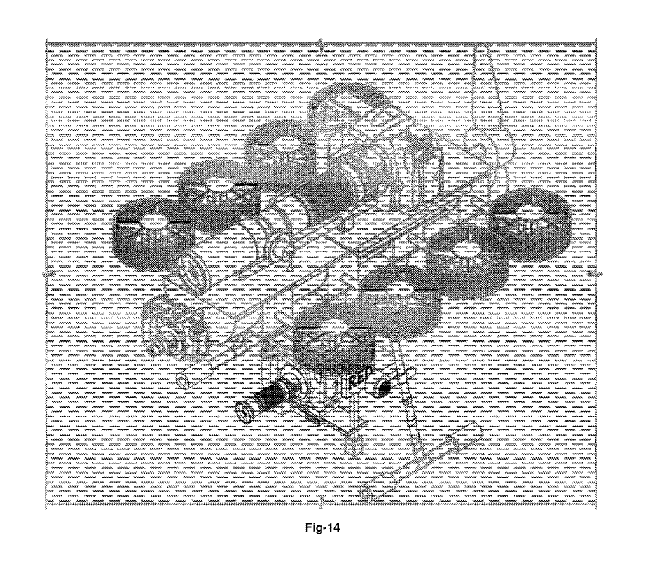

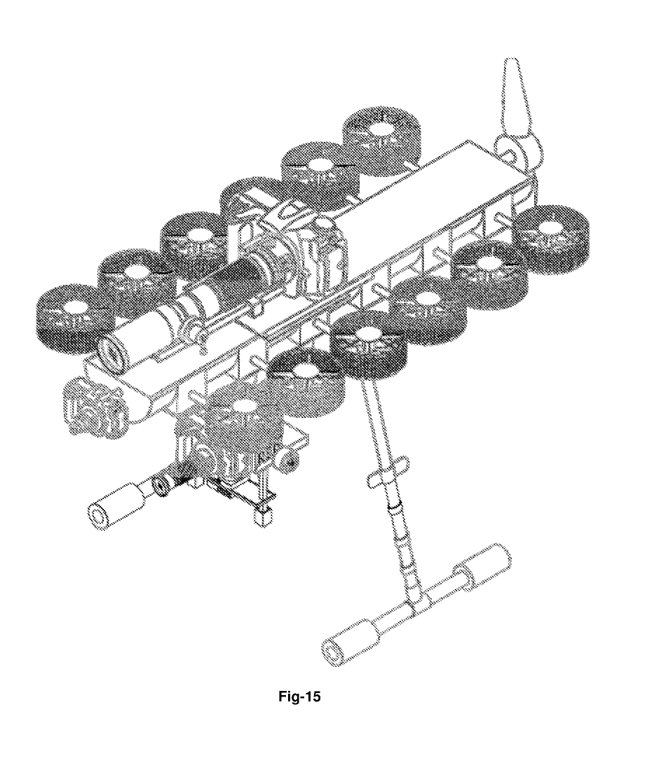

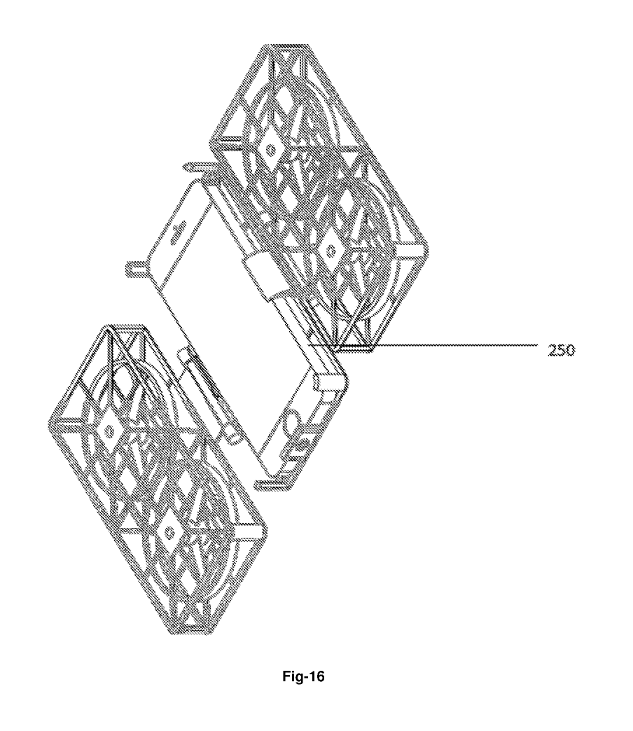

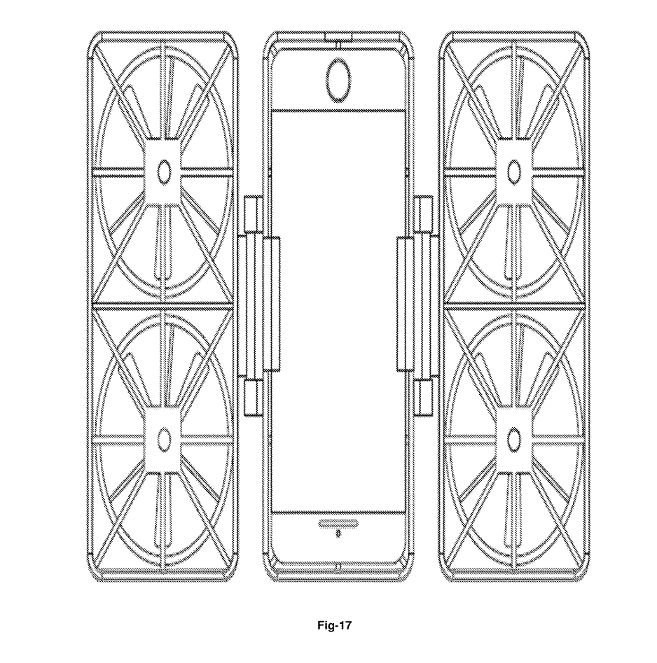

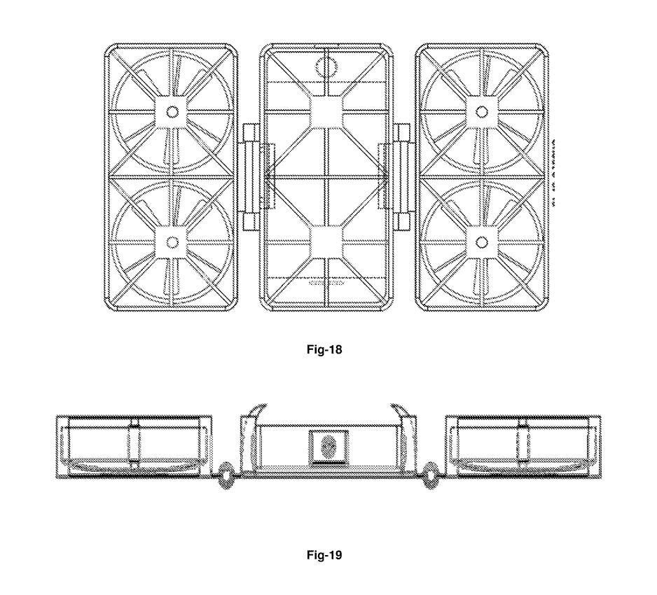

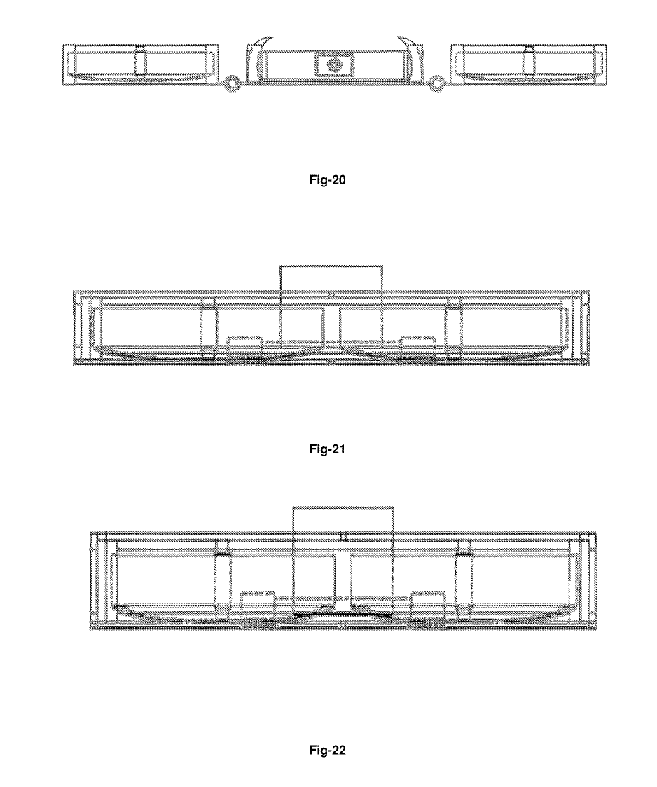

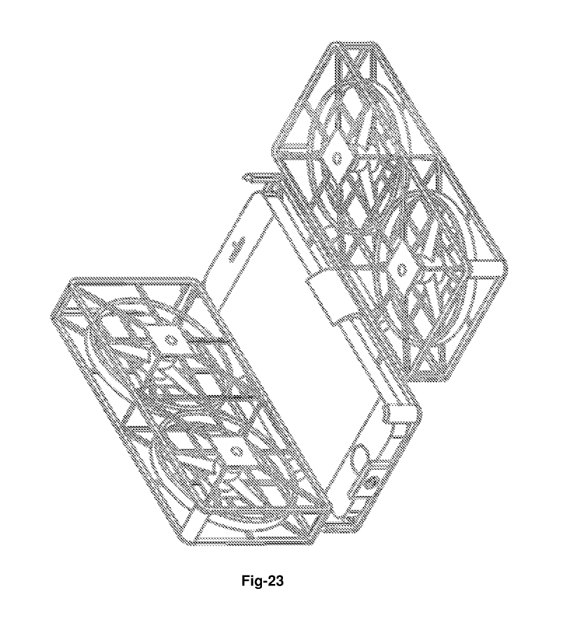

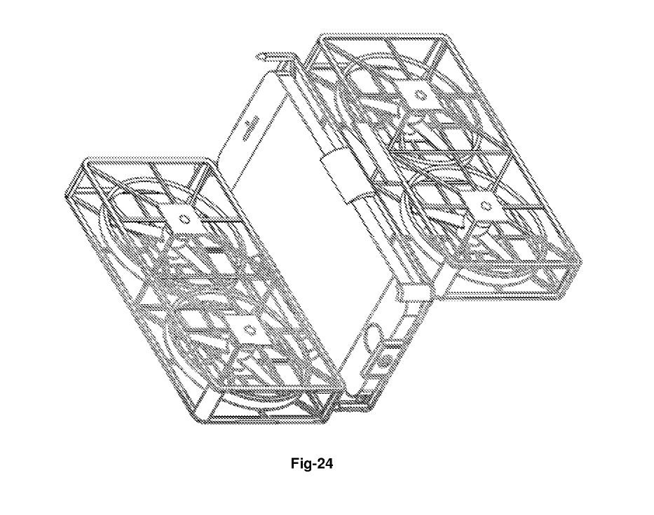

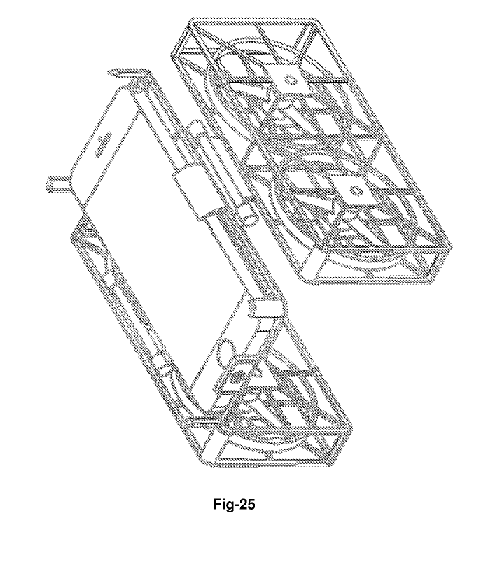

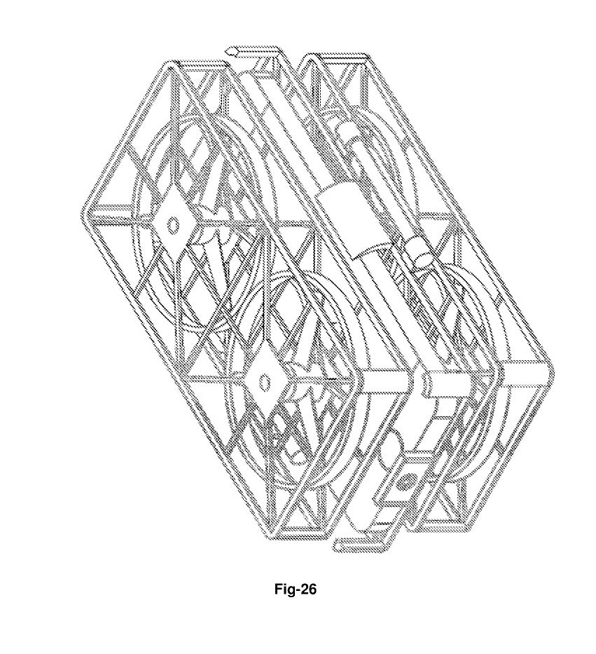

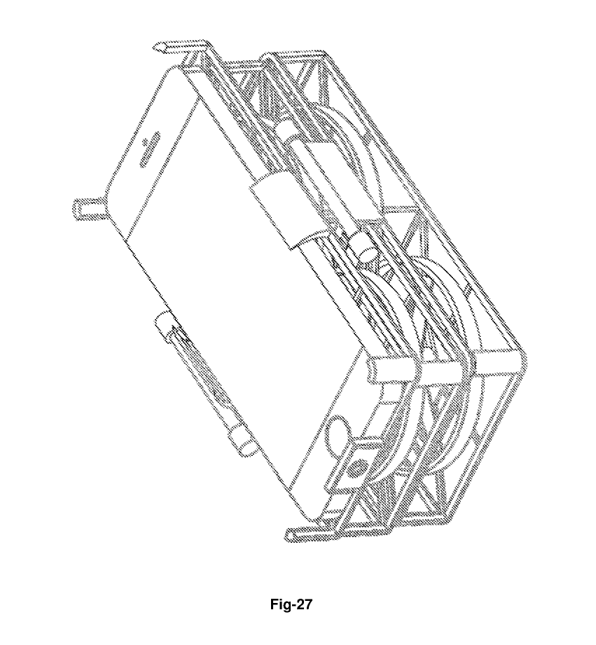

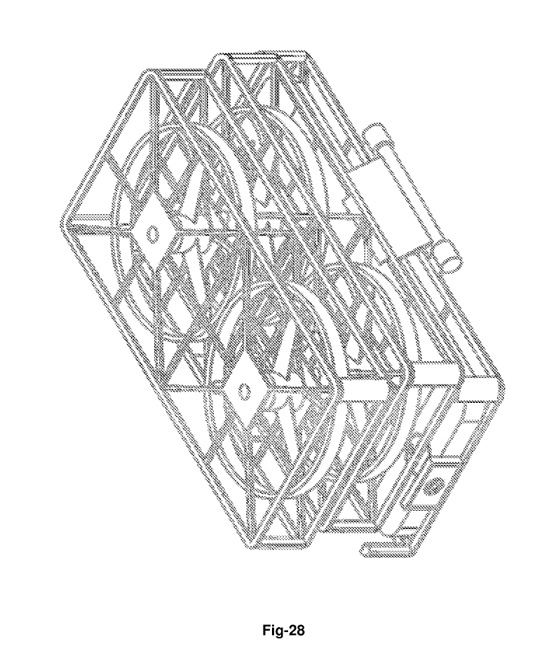

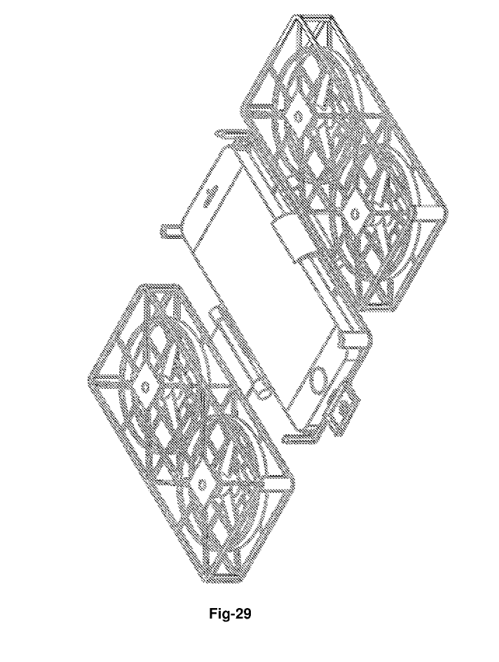

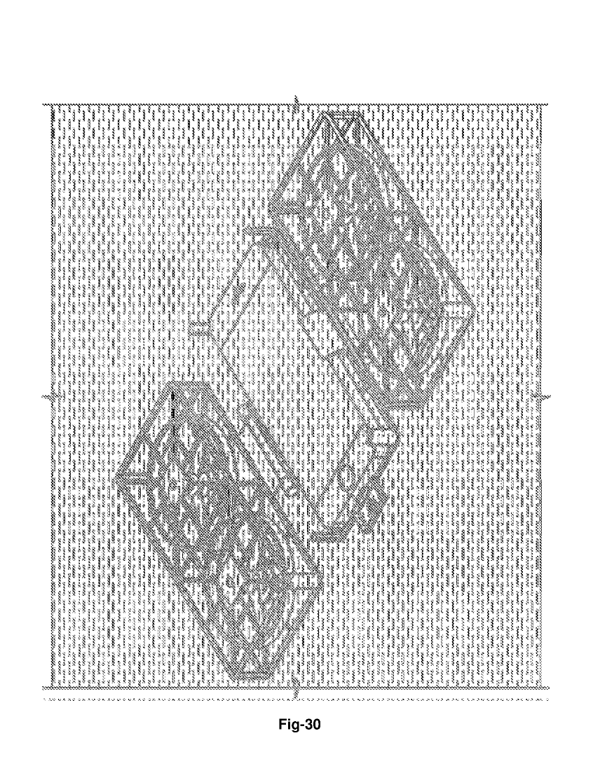

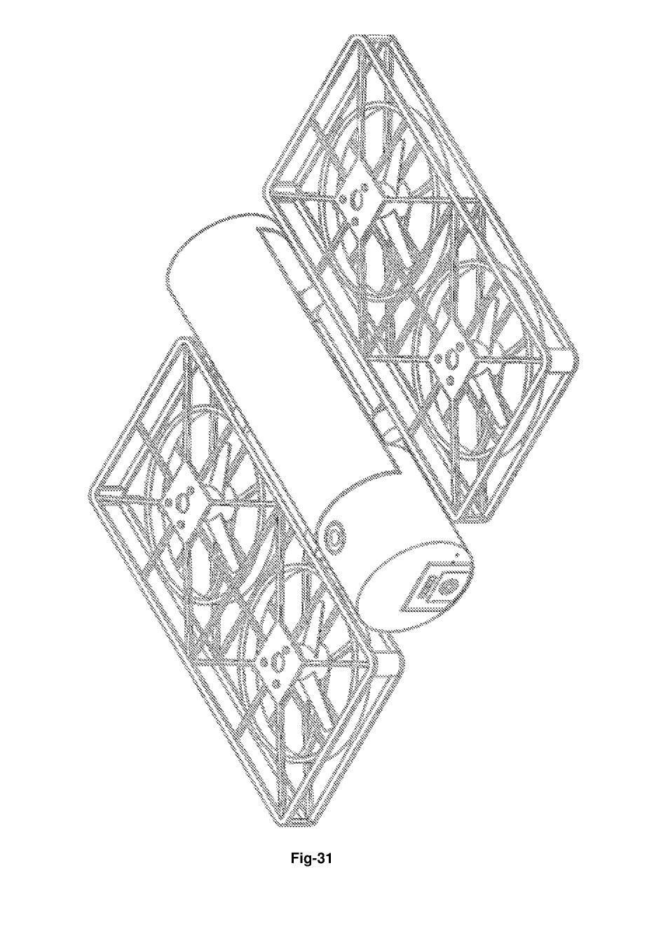

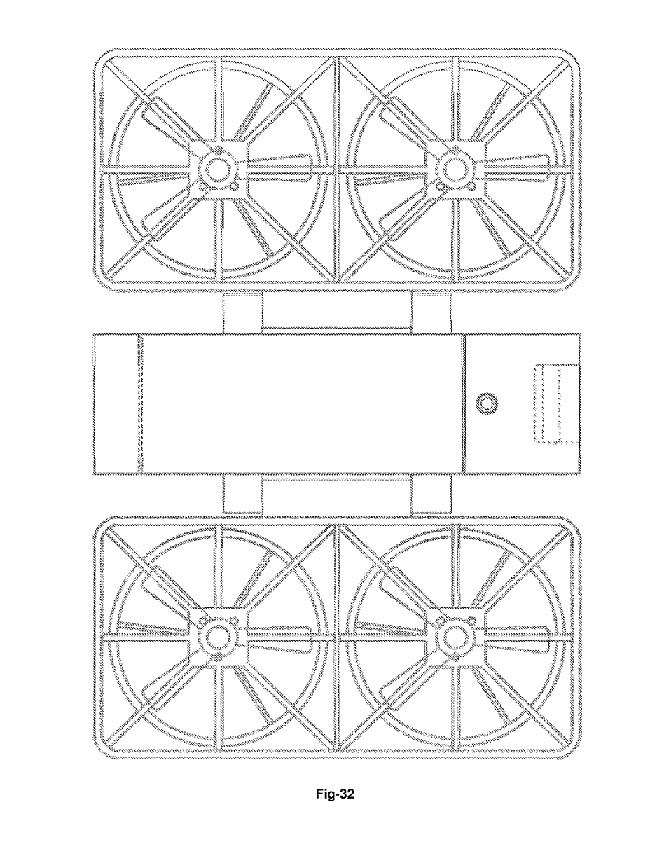

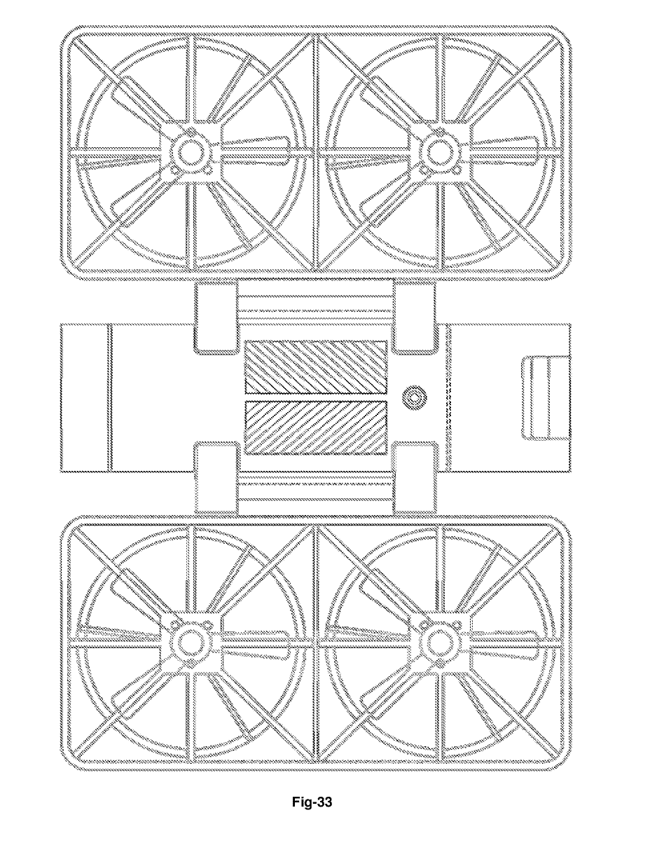

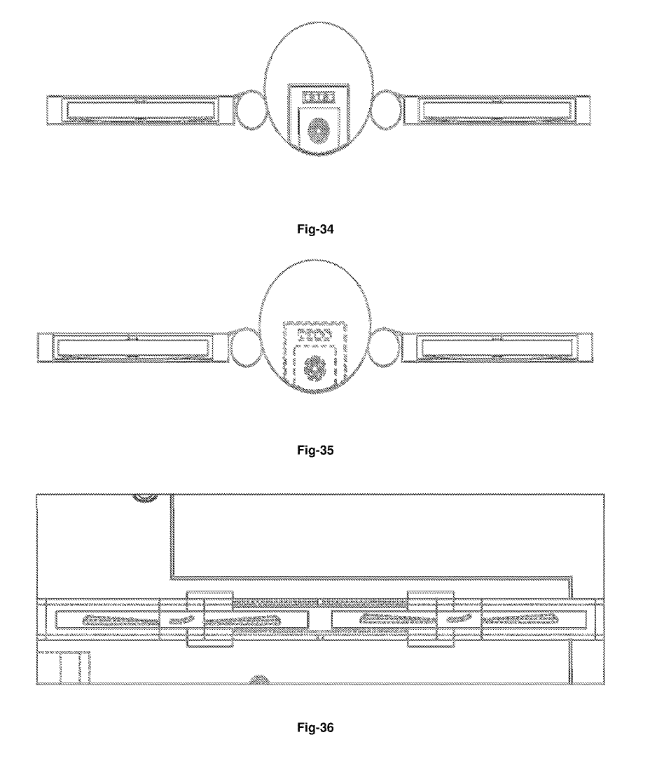

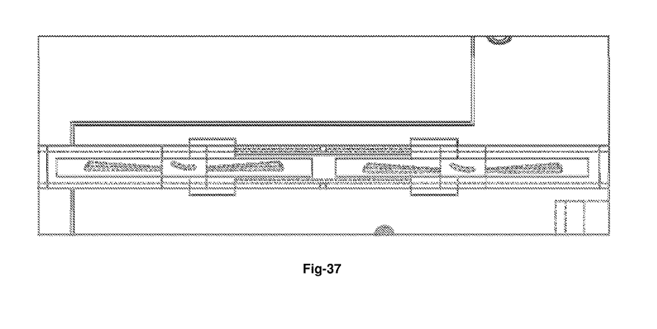

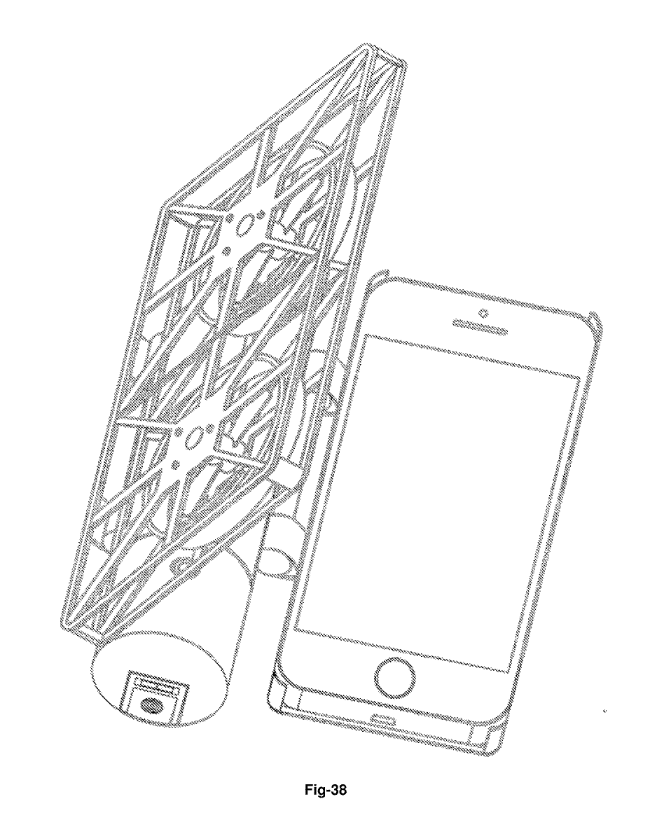

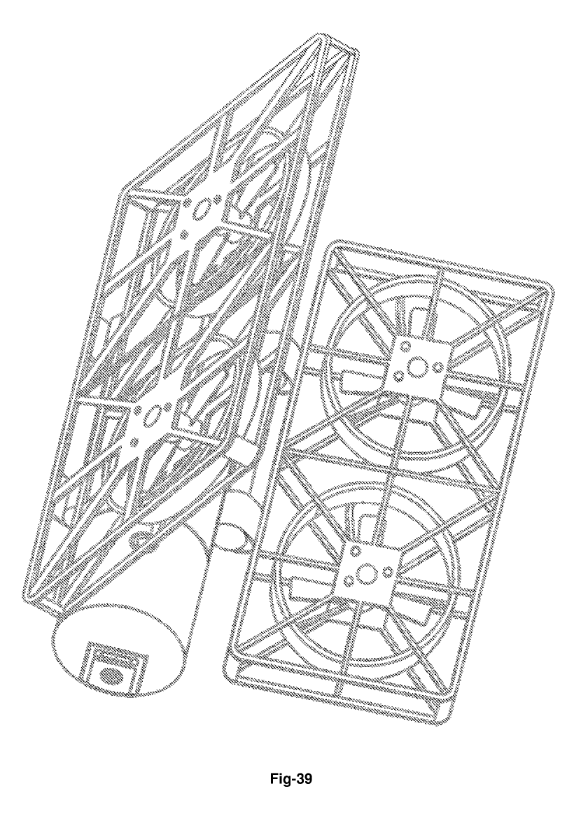

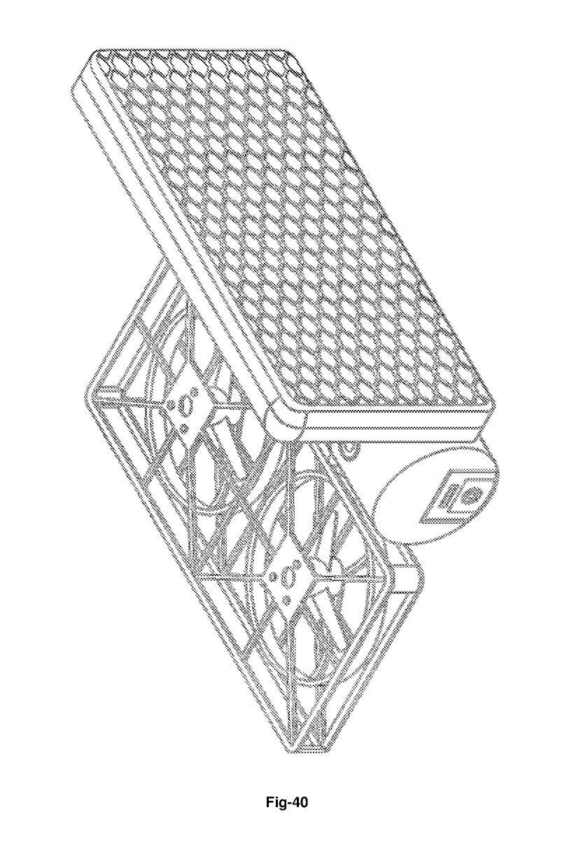

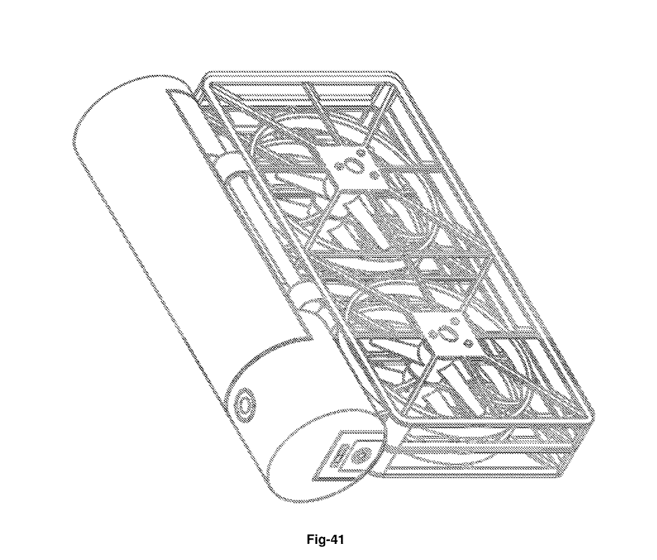

Referring now to FIG. 1, a VTOL unmanned aerial vehicle 100 with field view mapping and advanced collision system in accordance with the present embodiment is illustrated. the VTOL unmanned aerial vehicle 100 comprises a plurality of cameras 110, a plurality of rotors 120, a power supplying unit 130, a landing gear 140, a control device 150 and a communication system 160. The plurality of cameras 110 are adapted for providing a real-time first-person video and a real-time first-person view and normal footage video recording and 360-degree panoramic video recording used for virtual reality views and interactive videos.

Referring now to FIG. 1, a VTOL unmanned aerial vehicle 100, the VTOL unmanned aerial vehicle 100 consist plurality of printed circuit boards wherein many electronic devices are connected to the printed circuit board and is allowed to control the various devices connected to the printed circuit board.

The plurality of camera 110 is arranged on a camera stabilization system 112 arranged on a surface of the unmanned aerial vehicle 100.The plurality of camera 110 is configured to adjust one or more of the following parameters: zoom, shutter speed, aperture, ISO, focal length, depth of field, exposure compensation, white balance, video or photo frame size and orientation, camera resolution and frame rates; switch cameras used for live streaming, digitally stabilize video; capture panoramic photos, capture thermal measurements, edit colour correction, produce night vision images and video, produce flash.

The plurality of camera 110 captures images in a panoramic view, the plurality of camera capture 360-degree view of the environment, the plurality of cameras 110 are adapted to capture the video in different resolution, the plurality of cameras 110 are adapted for capturing the video in 4 k resolution, the plurality of cameras 110 are adapted for capturing the 3d models of the area captured by the unmanned aerial vehicle 100. The plurality of camera 110 comprises zooming lens, the zooming lens are adapted for capturing the distant objects, wherein the zooming lens are telescopic lens. The zooming lens have autofocus. The zooming lens 120 are adapted for the unmanned aerial vehicle 100 for capturing the images and videos of the object which are at a distance more than 10 miles without any errors and blurs.

Further the plurality of camera 110 is having at least one lens filter. Also the plurality of camera 110 are adapted for mapping the aerial view captured by the unmanned aerial vehicle 100. Specifically, the plurality of camera 110 is a depth camera. The depth camera is adapted for the finding the distance between the captured object and the unmanned aerial vehicle 100. Further, the camera stabilization system 112 includes a gimbal system adapted for capturing the images and video without disturbances, the camera stabilization 112 system is adapted for controlling the focal point and focus of the plurality of cameras 110.

In an embodiment the plurality of cameras 110 are adapted for mapping the area of the selected 2d maps, the plurality of cameras 110 map the selected maps according to the pre-selected map and sends the mapped images to a mobile device 200 using cellular data or wifi or wireless communication or Bluetooth etc.

In an embodiment the unmanned aerial vehicle 100 includes a site scan mapping platform (not shown in the figure). The site scan mapping platform is a fully automated and intelligent platform enabling the unnamed aerial vehicle 100 mapping platform for easy, fast and accurate. The aerial data acquisition enables to take informed and targeted action. Site scan mapping provides a level of insight that's invaluable to industries like agriculture, construction, mining, and land and resource management, or for gathering data for any area.

The site scan mapping involves various steps like plan, fly, process. Select the area to map using the application from the mobile devices 200, and the unmanned aerial vehicle 100 computes the flight path that will cover it. While in flight, on board software automatically captures all the right photos and geo-tags. In an embodiment the plurality of cameras 110 are adapted for the depth analysis and calculating the depths in water bodies calculating the depth in valleys and in mountain areas calculating the distance between the objects which are at depth.

In the present embodiment, the communication system 160 comprises a traffic control system and a collision avoidance system. The traffic control system is used to control the air traffic between the unmanned aerial vehicles. The collision avoidance system is adapted to communicate between the unmanned aerial vehicles using cellular network or Wi-Fi or Bluetooth. When the collision system detects any obstacle, the unmanned aerial vehicle 100 immediately halt forward motion, allowing the pilot to redirect the unamanned aerial vehicle to avoid a crash. This will work when the unmanned aerial vehicle 100 is flying forward, backward and side wards or at any direction obvious to a person skilled in the art.

In the present embodiment, the collision avoidance system is a low altitude tracking and avoidance system. Further, the collision avoidance system is configured to a remote device for controlling the unmanned aerial vehicle 100. The low altitude tracking and avoidance system platform connects leading airspace management technologies, such as sense and avoid, geofencing and aircraft tracking, into a service package for commercial and recreational drone operators as well as regulators and air traffic controllers.

Further referring to figure XX, the plurality of rotors 120 are tiltable rotors which tilt from 0-90 digress to change the direction of thrust there by creating the movement of vehicle 100 in all directions. The plurality of rotors 120 are having plurality of blades wherein the plurality of blades are aero foils adapted for creating the forward thrust and reverse thrust. Further the plurality of rotors 120 are connected to at least one motors arranged on the unmanned aerial vehicle 100. The plurality of rotors 120 are adapted for creating vertical lifting and landing.

Further, the power supplying unit 130 is a solar panel for supplying power to batteries and APU, thereby providing power to rotate the plurality of rotors 120. Specifically, the solar panel is retractable. The solar panels convert the solar energy and stored in the batteries and can be used as backup and as power bank for several electronic devices and to supply electricity to the various components of the unmanned aerial vehicle 100. The power supplying unit 130 comprises a plurality of sensors controlled by the control device 150 to detect the battery levels and power consumption of the unmanned aerial vehicle 100.

The plurality of sensors includes at least one GPS sensor and an at least one acoustic sensor. The at least one GPS sensor is adapted to guide the unmanned aerial vehicle to a desired location. The control device 150 is adapted to send navigation and position to the unmanned aerial vehicle 100 through the GPS sensor. The at least one acoustic sensor is adapted for finding minerals and ores in water and land.

The landing gears 140 are adapted for landing the unmanned aerial vehicle 100 to a dock safely. Also the landing gear 140 is adapted for horizontal stabilization. The landing gear 140 comprises a plurality of tilting cameras wherein the plurality of tilting camera are adapted for capturing the 360 degree view of the area.

The control device 150 is a remote control device adapted for giving commands and communication to the unmanned aerial vehicle 100. The control device 150 is a mobile phone or a tablet, a communication device. The control device 150 includes a tap fly, the tap fly allows the user to tap on a point on a map displayed in the control device 150 for choosing a flight path automatically thereby avoiding obstacles along the way of flight.

The unmanned aerial vehicle 100 further comprises a plurality of location sensor adapted to guide the unmanned aerial vehicle 100 to the desired location, the control device 150 is adapted for sending the navigation and position to the unmanned aerial vehicle 100 through the plurality of location sensors. The plurality of location sensors includes at least one acoustic sensor which are adapted for finding minerals and ores in water and land. The unmanned aerial vehicle 100 is adapted for underwater, surface, aerial for surveillance for capturing videos, for first person view, for recording 4 k resolution. The unmanned aerial vehicle 100 is adapted for aerial delivery, surface delivery and under water delivery, the unmanned aerial vehicle 100 sensors detect delivery address from the control device 150.

In another aspect a method 300 of controlling an unmanned aerial vehicle 100 in accordance with the present invention is illustrated. Referring now to figure XX, a flow chart of the method 300 in accordance with the present invention is provided. For the sake of brevity, the method 300 is explained in conjunction with the unmanned aerial vehicle 100 explained above.

The method 300 starts at step 310

At step 320, a plurality of cameras 110 captures a real-time first-person video and a real-time first-person view and normal footage video recording and 360-degree panoramic video recording used for virtual reality views and interactive video.

At step 330, a control device 150 communicates with an unmanned aerial vehicle 100.

At step 340, the unmanned aerial vehicle 100 is safe landed using a landing gear 140 provided on the unmanned aerial vehicle 100.

Therefore, the present invention has an advantages is to provide an unmanned aerial vehicle with field view mapping and advanced collision system. The present invention can capture area mapping. The present invention can also communicate with other unmanned vehicles.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A method for an amphibious vertical take off and landing unmanned device with Al data processing apparatus, the method steps comprising:
a plurality of cameras adapted for providing a real-time first-person video and a real-time first-person view and normal footage video recording and 360-degree panoramic video recording used for virtual reality views and interactive videos;
a plurality of rotors configured laterally on a periphery of the unmanned aerial vehicle adapted for creating a thrusting force thereby moving the unmanned aerial vehicle towards the thrusting force;
a self-powered solar cells and wind turbine arrangement to power and charge the batteries;
a power supplying unit for supplying power to the plurality of rotors for moving the unmanned aerial vehicle;
an artificial intelligence (Al) two way selfie photo and selfie video integrated apparatus;
a water proof body;
a landing gear adapted for safe landing of the unmanned aerial vehicle;
a control device adapted to set a flight path and area to map by the unmanned aerial vehicle; and
an artificial intelligence (Al) communication system adapted for sharing the flight path and position of the unmanned aerial vehicle thereby controlling the unmanned aerial vehicle in a predetermined path;
capturing a real-time first-person video and a real-time first-person view and normal footage video recording and 360-degree panoramic video recording used for virtual reality views and interactive video using a plurality of cameras;
controlling the unmanned aerial vehicle by communicating through a control device; and safe landing the unmanned aerial vehicle using a landing gear provided on the unmanned aerial vehicle;
an onboard or ground station electricity generator comprising a plurality of solar cells, one or more wind turbines, and one or more hydroelectric generators; a 3D or 4D printed parts;a carbon fiber hybrid solar cells; a light detection and ranging lidar;
and an ultrasonic radar sensor; wherein at least one motor of the plurality of motors includes a solar turbine powered master impeller motor disposed centrally in the device, solar turbine powered master impeller motor comprising an electric-drive impeller contained in a compression chamber and having an axis of rotation oriented perpendicularly to an axis of the device, the solar turbine powered master impeller motor being powered by a solar film, the solar film being integrated on an upper surface of the device, a lower surface of the device, and the at least one wing of the device, and the solar turbine powered master impeller motor being powered by the electrical power storage device;
an electrical machine comprising a stator electrically connected to the electrical power storage device, wherein the electrical machine acts as an electric motor for driving rotation of the first rotor by using the electrical power storage device, and wherein the
electrical machine acts as an electrical power generator for re-charging the electrical power storage device by causing the rotation of the second rotor under action of a wind current.

2. The method of claim 1, wherein the VTOL unmanned aerial device, the plurality of camera is arranged on a camera stabilization system, arranged on a surface of the VTOL and hover unmanned aerial vehicle.

3. The method of claim 1, wherein the plurality of cameras are configured to adjust one or more of the following parameters: zoom, shutter speed, aperture, ISO, focal length, depth of field, exposure compensation, white balance, video or photo frame size and orientation, camera resolution and frame rates; switch cameras used for live streaming, digitally stabilize video; capture panoramic photos, capture thermal measurements, edit color correction, produce night vision images and video, produce flash.

4. The method of claim 1, wherein the plurality of camera captures images in a panoramic view, the plurality of camera capture 360-degree view of the environment, the plurality of cameras are adapted to capture the video in different resolution, the plurality of cameras are adapted for capturing the video in 4 k resolution, the cameras are adapted for capturing the 3d models of the area captured by the unmanned aerial vehicle.

5. The method of claim 1, further comprising:
the plurality of camera comprises zooming lens, the zooming lens are adapted for capturing the distant objects, wherein the zooming lens are telescopic;
the plurality of camera is having at least one lens filter;
the plurality of camera are adapted for mapping the aerial view captured by the unmanned aerial vehicle;
the plurality of camera is a depth camera, the depth camera is adapted for the finding the distance between the captured object and the unmanned aerial vehicle.

6. The method of claim 1,wherein the communication system comprises:
a traffic control system used to control the air traffic between the unmanned aerial vehicles;
a collision avoidance system adapted to communicate between the unmanned aerial vehicles using wireless cellular network 4G, 5G, 6G, 7G and upper or Wi-Fi or Bluetooth;
wherein the collision avoidance system is a low altitude tracking and avoidance system;
wherein the collision avoidance system is configured to a remote Al device for controlling the unmanned aerial vehicle.

7. The method of claim 1, wherein the plurality of rotors are tillable rotors which tilt from 0-90 digress to change the direction of thrust force, the plurality of rotors are having plurality of blades wherein the plurality of blades are aero foils adapted for creating the forward thrust and reverse thrust.

8. The method of claim 1,wherein the power supplying unit is a solar panel for supplying power to batteries and APU, thereby providing power to rotate the plurality of rotors, wherein the solar panel is retractable.

9. The method of claim 1,wherein the power supplying unit comprises a plurality of sensors controlled by the Al control device to detect the battery levels and power consumption of the unmanned aerial vehicle.

10. The method of claim 1,wherein the plurality of sensors includes:
at least one GPS sensor adapted to guide the unmanned aerial vehicle to a desired location, the Al control device is adapted to send navigation and position to the unmanned aerial vehicle through the GPS sensor; and
at least one acoustic sensor adapted for finding minerals and ores in water and land.

11. The method of claim 1,wherein the landing gears are adapted for landing the unmanned aerial vehicle to a dock safely, the landing gear is also adapted for horizontal stabilization, wherein the landing gear comprises a plurality of tilting cameras wherein the plurality of tilting camera are adapted for capturing the 360 degree view of the area.

12. The method of claim 1,wherein the Al control device is a remote control device adapted for giving commands arid communication to the unmanned aerial vehicle, wherein the control device is one or more including: a mobile phone, a watch, a headset, a an AR headset, a VR headset, a tablet, a communication device and other Al mobile arid wearable device.

13. The method of claim 1, wherein the Al control device includes a tap fly, the tap fly allows the user to tap on a point on a map displayed in the control device for choosing a flight path automatically thereby avoiding obstacles along the way of flight, and a tap autonomous coming home.

14. The method of claim 1,wherein the unmanned aerial vehicle further comprises a plurality of location sensor adapted to guide the unmanned aerial vehicle to the desired location, the control device is adapted for sending the navigation and position to the unmanned aerial vehicle through the plurality of location sensors, wherein the plurality of location sensors includes at least one acoustic sensor which are adapted for finding minerals and ores in water and land.

15. The method of claim 1, wherein camera stabilization system includes a gimbal system adapted for capturing the images and video without disturbances, the camera stabilization system is adapted for controlling the focal point and focus of the plurality of cameras.

16. The method of claim 1, wherein the unmanned aerial vehicle is adapted for underwater, surface, aerial for surveillance for capturing videos, for first person view, for recording 4 k, 5 k, 6 k, 7 k, 8 k, 9 k and upper resolution.

17. The method of claim 1, wherein the unmanned aerial vehicle is adapted for aerial delivery, surface delivery and under water delivery, the unmanned aerial vehicle sensors autonomous detect deliver address from the Al control device.

18. A system of an amphibious vertical take off and landing unmanned device with Al data processing apparatus, the system comprising:
a collision avoidance, flight stabilization, and multi-rotor control system for an amphibious VTOL unmanned device, the system comprising: a flight and dive control device configured to perform one or more of the following: auto level control, altitude hold, return to an operator automatically, return to the operator by manual input, operating auto-recognition camera, monitoring a circular path around a pilot, and controlling autopilot, supporting dynamic and fixed tilting arms; one or more sensors and one or more cameras configured to control one or more of the following: obstacle avoidance, terrain and Geographical Information System mapping, close proximity flight including terrain tracing, and crash resistant indoor navigation; an autonomous takeoff device; an auto-fly or dive to a destination with at least one manually or automatically generated flight plan; an auto-fly or dive to the destination by tracking monuments; a direction lock; dual operator control; a transmitter and receiver control device comprising one or more antennas, the one or more antennas including high gain antennas;
the transmitter and receiver control device further comprising a lock mechanism operated by one or more of the following: numerical passwords, word passwords, fingerprint recognition, face recognition, eye recognition, and a physical key; and at least one electronic speed controllers (ESC) selected from a standalone ESC and an ESC integrated into a power distribution board of the amphibious VTOL unmanned device.

19. The system of claim 18, wherein the one way and two way telemetry device is configured to control an on screen display to inform a user of battery voltage, current draw, signal strength, minutes flown, minutes left on battery, joystick display, flight and dive mode and profile, amperage draw per unit of time, GPS latitude and longitude coordinates, an operator position relative to a position of the amphibious VTOL unmanned device, number of GPS satellites, and artificial horizon displayed on a wearable device, the wearable device being selected from a tablet, a phone, and the headset, wherein the one way and two way telemetry device is configured to provide a follow-me mode when the amphibious VTOL unmanned device uses the wearable device as a virtual tether to track the user via the camera when the user moves;
further comprising a radio control device operable to control one or more of the following: an omnidirectional or directional antenna, antenna tracking on a ground station or onboard the amphibious VTOL unmanned device tilt, a low pass filter, ninety degree adapter, a detachable module for RC communication on a channel having a frequency selected from 72 MHz, 75 MHz, 433 MHz, and 1.2 GHz and 1.3 GHz, adjustable dual rates and exponential values, at least one dial or joystick for controlling
movement of a camera stabilization device, one or more foot pedals, a slider, a potentiometer, and a switch to transition between a flight profile and a dive profile, and wherein the radio control device is further operable to perform automatic obstacle
avoidance and automatic maneuvering around an obstacle when the amphibious VTOL unmanned device performs a flight in a predetermined direction, wherein the radio control device is operable to instruct a plurality of amphibious VTOL unmanned
device to follow a single subject and capture a plurality of views of the subject, wherein the radio control device is controlled by stick inputs and motion gestures;
further comprising: a navigation device configured to: enable autonomous flying at low altitude and avoiding obstacles; evaluate and select landing sites in an unmapped terrain;land safely using a computerized self-generated approach path;enable a pilot
aid to help a pilot to avoid obstacles and select landing sites in unimproved areas during operating in low-light or low-visibility conditions;
detect and maneuver around a man lift during flying; detect high-tension wires over a desert terrain; and enable
operation in a near earth obstacle rich environment; and a navigation sensor configured to:map an unknown area where obstructions limited landing sites;identify level landing sites with approach paths that are accessible for evacuating a simulated
casualty; build three-dimensional maps of a ground and find obstacles in a path; detect four-inch-high pallets, chain link fences, vegetation, people and objects that block a landing site; enable continuously identifying potential landing sites and develop
landing approaches and abort paths; select a safe landing site being closest to a given set of coordinates; wherein the navigation sensor includes an inertial sensor and a laser scanner configured to look forward and down, wherein the navigation sensor is
paired with mapping and obstacle avoidance software, the mapping and obstacle avoidance software being operable to keep a running rank of the landing sites, approaches and abort paths to enable responding to unexpected circumstances.

20. The system of claim 18, wherein the one or more sensors are selected from a group comprising: individual sensors, stereo sensors, ultrasonic sensors, infrared sensors, multispectral sensors, optical flow sensors, and volatile organic compound
sensors, wherein the one or more sensors are provided for intelligent positioning, collision avoidance, media capturing, surveillance, and monitoring, wherein the system includes an open source code and an open source software development kit.
wherein the one way and two way telemetry device is configured to control an on screen display to inform a user of battery voltage, current draw, signal strength, minutes flown, minutes left on battery, joystick display, flight and dive mode and profile,
amperage draw per unit of time, GPS latitude and longitude coordinates, an operator position relative to a position of the amphibious VTOL unmanned device, number of GPS satellites, and artificial horizon displayed on a wearable device, the wearable
device being selected from a tablet, a phone, and the headset, wherein the one way and two way telemetry device is configured to provide a follow-me mode when the amphibious VTOL unmanned device uses the wearable device as a virtual tether to track the user via the camera when the user moves.
